(19) United States
(12) Patent Application Publication
(10) Pub. No.: US 2021/0024156 A1
(43) Pub. Date: Jan. 28, 2021

(54) Bicycle Saddle

(71) Applicant: Ergon International GmbH, Koblenz (DE)

(72) Inventors: Andreas Krause, Koblenz (DE); Franc Arnold, Koblenz (DE)

(21) Appl. No.: 16/971,359

(22) PCT Filed: Feb. 14, 2019
(86) PCT No.: PCT/EP2019/053728

§ 371 Date: Aug. 20, 2020

(30) Foreign Application Priority Data
Feb. 21, 2018 (DE) 20 2018 000 895.8

(51) Int. Cl. B62J 1/26; B62J 1/08

(52) U.S. Cl. CPC B62J 1/26; B62J 1/08

(57) ABSTRACT

A bicycle saddle including a saddle shell. A saddle frame is arranged on a lower side of the saddle shell. A saddle cushion is arranged on the upper side of the saddle shell (24). The saddle cushion includes at least two cushion elements. According to the disclosure, a connection layer is provided between at least two cushion elements for improving the connection of these cushion elements.

### CROSS-REFERENCE TO RELATED APPLICATIONS

This application is the United States national phase of International Application No. PCT/EP2019/053728 filed Feb. 14, 2019, and claims priority to German Patent Application No. 20 2018 000 895.8 filed Feb. 21, 2018, the disclosures of which are hereby incorporated by reference in their entirety.

### BACKGROUND OF THE INVENTION

### Field of the Invention

The disclosure relates to a bicycle saddle.

### Description of Related Art

Bicycle saddles comprise a saddle shell, the lower side of which is usually provided with a saddle frame for connection to a saddle post. A seat cushion is provided on the upper side of the saddle shell. The seat cushion may be composed of a plurality of cushion elements. This is advantageous e.g. for forming regions having different characteristics such as different hardness, different rebound characteristics etc. However, providing a plurality of cushion elements has the disadvantage that the connection of the cushion elements is not reliable, in particular in the case of cushion elements of different materials.

From DE 20 2015 005 873 a special bicycle saddle is known. The same comprises a double saddle shell. In addition to a lower saddle shell connected to the saddle frame, a further saddle shell of hard plastic material is provided between two cushion elements. This allows for a movement of the upper saddle shell relative to the lower saddle shell, since a cushion material or another elastomeric body is arranged between the two saddle shells. Although sitting comfort can be significantly improved by such a bicycle saddle, this is a relatively complex structure.

It is an object of the present disclosure to provide a bicycle saddle in which the connection of a plurality of cushion elements of a saddle cushion is improved.

The object is achieved according to this disclosure with a bicycle saddle.

### SUMMARY OF THE INVENTION

The bicycle saddle of the present disclosure comprises a saddle shell, on the lower side of which a saddle frame or a corresponding connection between the saddle shell and the saddle post is provided. On the upper side of the saddle shell a saddle cushion is arranged. According to the disclosure, the saddle cushion comprises at least two cushion elements. The cushion elements can have different damping characteristics, different rebound characteristics, different hardness and the like. The cushion elements are arranged such that they overlap each other at least partially. According to the disclosure a connection layer is provided between at least two cushion elements. In a particularly preferred embodiment, the connection layer is designed such that it is a not self-supported component. This can be achieved in particular by the design, the choice of material, as well as the thickness of the material. Thereby, it is ensured that even in the event of transversal forces occurring during pedaling a reliable connection between the two cushion elements is maintained.

The connection layer preferably comprises a film and/or a non-woven. Here, it is further preferred that the film and/or the non-woven have recesses. Providing recesses is advantageous in that, depending on the production method, the material of one of the two cushion elements enters one of the recesses or penetrates the connection layer so that the connection between the connection layer and the corresponding cushion element is improved. This is possible in particular in such a manner that the connection layer is already provided during the manufacture of the corresponding cushion element, e.g. placed in an injection mold or another mold.

In particular it is preferred that the connection layer comprises a synthetic and/or organic fabric and is preferably made of synthetic and/or organic fabric. The use of a fabric as a connection layer has the particular advantage that the cushion material enters the fabric due to the structure thereof and enters the fabric due to the structure of the connection layer as a fabric layer, and that in this manner a strong connection between at least one of the two cushion elements and the connection layer is realized in a simple manner. Possibly, the use of connection layers is feasibly that are made of a combination of fabric and/or non-woven and/or film.

It is particularly preferred that the connection layer has a small thickness of in particular less than 1.5 mm and particularly preferred less than 1 mm. It is particularly preferred that the connection layer has a thickness of 0.5 to 1 mm.

It is further possible to arrange the connection layer, which is in particular designed as a film and/or non-woven and/or fabric, only in a partial region. In this respect, it is particularly preferred to arrange the connection layer in the sitting region of the bicycle saddle, since there the greatest forces and moments are induced into the saddle in particular via the sitbones of the user.

In a particularly preferred embodiment, the connection layer is pre-tensioned or at least comprises pre-tensioned partial elements. The stability can be further improved by such pre-tensioning. Such a pre-tensioning is effected in the sitting region of the bicycle saddle. In this respect it is particularly preferred that the pre-tensioning is effected transversely to the longitudinal direction of the saddle. In particular it is possible to provide fiber material in the connection layer or to manufacture the connection layer from fiber material and to pre-tension the fibers at least partially, in particular completely. Knitted polypropylene fibers are particularly suited for this purpose.

Other suitable materials for the connection layer are in particular polyamide fabrics, polyethylene films or polyethylene coatings. In particular, the connection layer may be of a multi-layered design, wherein different material characteristics such as pre-tension, elasticity etc. may be realized depending on the layer. It is possible in particular with multi-layered connection layers to realize different characteristics in different regions of the saddle such as e.g. in the sitting region, in the central region or in the region of the saddle tip. As such, it is possible e.g. to design a connection layer that is pre-tensioned in the sitting region in particular transversally to the longitudinal direction of the saddle and is not-pre-tensioned in the region of the saddle tip or is pre-tensioned in the longitudinal direction in this region.

In a preferred embodiment of the disclosure a recess is provided in one of the cushion elements between which the connection layer is arranged, or is provided in both cushion elements in the sides facing each other. Preferably, the connection layer is arranged in this recess. Preferably, this has the advantage that, possibly, no connection layer is provided at the outer edge so that a good and possibly optically perfect connection of the two cushion elements can be realized.

Providing a connection layer between the at least two cushion elements further has the advantage that a higher stability of the cushion elements can be realized for cushion elements protruding laterally beyond the saddle shell so that a large protrusion of possibly even more than 1 cm is possible.

Here it is particularly preferred to pre-tension the connection layer especially in this region, i.e. in the region of the protrusion.

In another preferred embodiment a lower cushion element is configured such that it covers the upper side of the saddle shell for at least 50%, in particular at least 70% and, as is particularly preferred, covers the same completely. Possibly, a further, e.g. a third or even a fourth cushion element may be provided to change the damping characteristics, rebound characteristics etc. of the saddle cushion. This may be advantageous in particular for the region of the sitbones, in the region of the saddle tip or other regions subjected to other particular loads. For example, gel elements or the like may be provided as further cushion elements.

In a further preferred embodiment, an upper cushion element is arranged and configured such that it covers the lower side of the saddle shell for at least 50%, in particular at least 70% and, as is particularly preferred, covers the same completely. It is also possible that the lower cushion element covers the upper side of the saddle shell only partially and that, in that case, the upper cushion element is configured such that it covers all of the upper side of the saddle shell in top plan view. In this respect, there may be regions in which the saddle cushion is multi-layered, as well as there may be regions in which the saddle cushion is only single-layered. At least in the single-layered regions it is preferred that the cover layer is fixed to the lower side of the saddle shell as usual.

In a particularly preferred embodiment, the in particular lower cushion element is configured as an elastomer body. In particular, the elastomer body comprises an open-cell or closed-cell foam and, as is particularly preferred, made of such foam.

In particular closed-cell foams are preferred. It is particularly preferred that in particular the lower cushion element comprises one or a plurality of particulate foams or is made in particular of one or a plurality of particulate foams. As a base material, E-TPU (expanded thermoplastic polyurethane), EPP (expanded polypropylene), EPS (expanded polystyrene), EPE (expanded polyethylene) or similar foams are particularly preferred. Generally, particulate foams are formed by small spheres of the expanded base material. These particles formed as spheres or other bodies are given their final shape in a tool, such as a mold or the like, using temperature and, possibly, water vapor. In particular, particulate foams have the advantage that they have a low density, a good heat/cold insulation and good damping characteristics.

It is particularly preferred that the lower cushion element or the main cushion element comprises E-TPU (expanded thermoplastic polyurethane) and, as is particularly preferred, is made from this material. The material manufactured by BASF under the product name “Infinergy” is particularly suited for this purpose. Methods for producing E-TPU are described e.g. in EP 692510, WO 00/44821, EP 11 74 459 and EP 11 74 458. It is further preferred that the cushion element is made of EVA (ethylene vinyl acetate) or that the main cushion element is made of a material that includes EVA. Further, materials that can be used are EPP (expanded polypropylene), TPE (thermoplastic elastomer) or E-TPE (expanded thermoplastic elastomer), EPS (expanded polystyrene) and EPE (expanded polyethylene). A combination of these materials or a combination of these materials with other materials is also possible, e.g. in a multi-layered structure. In particular, mixtures with co- or terpolymers can also be used. Thereby, different damping and movement features of the damper element can be obtained. Likewise, it is possible to provide a greater compaction of the corresponding materials in different regions, so that the damping and movement features can be influenced thereby.

Another well suited material for forming in particular the lower cushion element is a polyester-based PU-material. The material offered by BASF under the tradename “Elastopan” is particularly well suited. Preferably, the cushion element comprises such a material or is made from the same, wherein it is again possible to combine this material with other materials described.

It is particularly preferred that in particular the lower cushion element comprises one or a plurality of particulate foams or is made in particular of one or a plurality of particulate foams. As a base material, E-TPU (expanded thermoplastic polyurethane), EPP (expanded polypropylene), EPS (expanded polystyrene), EPE (expanded polyethylene) or similar foams are particularly preferred. Generally, particulate foams are formed by small spheres of the expanded base material. These particles formed as spheres or other bodies are given their final shape in a tool, such as a mold or the like, using temperature and, possibly, water vapor. In particular, particulate foams have the advantage that they have a low density, a good heat/cold insulation and good damping characteristics.

The lower cushion element is preferably made from moisture repellent material at least in the edge region.

In particular, in a sitting region of the saddle, the cushion element has a modulus of elasticity between 0.1 to 10 MPa, in particular 0.1 to 5 MPa, and particularly preferred 0.1 to 1.0 MPa. The particularly preferred material “Infinergy E-TPU” has a modulus of elasticity of 0.1 to 0.5 MPa.

Moreover, it is particularly preferred that in particular the lower cushion element has a low weight due to its low density. Specifically, the elastomeric body has a density of less than 1 g/cm³, particularly preferred less than 0.5 g/cm³ and in particular less than 0.2 g/cm³. One of the particularly preferred materials, the material Elastil, has a density in the range of 0.05 to 0.2 g/cm³.

The rebound behavior of in particular the lower cushion element is preferably in a range of more than 30%, in particular more than 40% and particularly preferred more than 50%.

The upper cushion element covers the lower cushion element at least partially, preferably completely. Specifically, the upper cushion element covers the lower cushion element for at least 50%, in particular at least 70% and, as is particularly preferred, completely.

The upper cushion element is preferably made of a foamable material, in particular foamed plastic material. A PU foam is particularly useful.

The saddle shell preferably comprises PP, PA6 or PA12 as its material or is made from these materials. According to the disclosure, the modulus of elasticity of the saddle shell is in a range from 1000 to 10000 MPa, preferably 2500 to 6000 MPa and particularly preferred in a range from 3000 to 5000 MPa. It is preferred to use PP (modulus of elasticity: 1100 to 1450 MPa), PP GF20 (modulus of elasticity: ca. 2900 MPa) and/or PA6 GF15 (modulus of elasticity: 4500 to 6500 MPa).

Moreover, the saddle shell may be made from TPU. TPU has the particular advantage that different moduli of elasticity can be achieved over a large range. The moduli of elasticity are in particular in a range from 500-6000 MPa.

Further, the saddle shell may also be made from a combination of the materials mentioned or also in combination with other materials.

It is further possible to span the saddle cushion with a cover layer. Here, at least a part of the saddle cushion, preferably the entire saddle cushion, is completely spanned by a cover layer at least on the upper side. Providing such a cover layer is suitable or possibly even required if one of the two cushion elements absorbs moisture.

Preferably, at least the lower cushion element is made of a moisture repellent material so that the same does not have to be spanned by a cover layer.

A substantial further advantage of providing a connection layer between two cushion elements is that the saddle shell can be configured to be narrower. In particular, larger lateral protrusions of the cushion elements are possible, since transversal forces can be received or transferred better due to the connection layer of the disclosure.

### BRIEF DESCRIPTION OF THE DRAWINGS

The disclosure will be explained hereunder in detail with reference to a preferred embodiment and the accompanying drawings.

In the Figures:

FIG. 1 shows a schematic top plan view on a bicycle saddle,

FIG. 2 is a schematic side view of the bicycle saddle shown in FIG. 1, and

FIG. 3 is a schematic sectional view along the line in FIG. 1.

### DESCRIPTION OF THE INVENTION

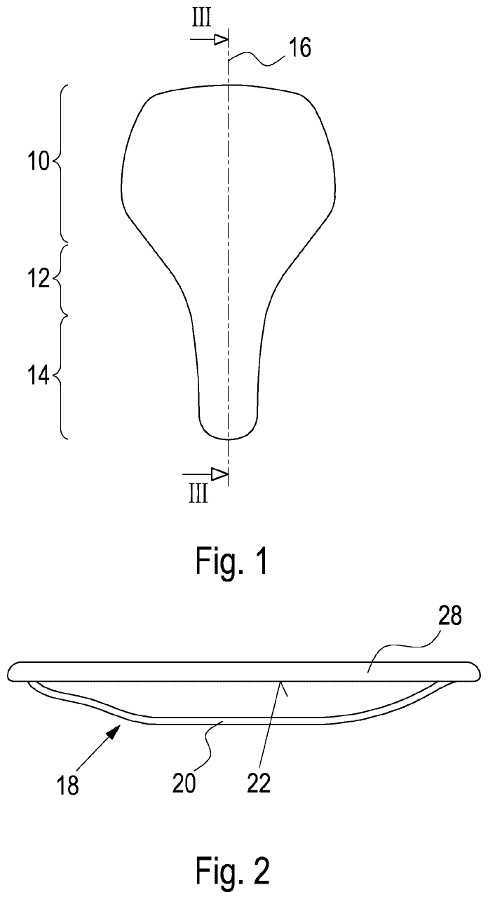

In top plan view (FIG. 1), a bicycle saddle comprises a sitting region 10 adjoined by a central region 12. The central region 12 passes into the saddle tip 14. Here, the saddle tip 14 is narrower in shape and the sitting region 10 is wider so that the greatest part of the weight of the bicycle is received in the sitting region in particular via the sitbones. The bicycle saddle is formed symmetric with respect to a central axis 16 that extends in the longitudinal direction.

A lower side 22 of a bicycle saddle is connected to a saddle frame 18 (FIG. 2). The embodiment of the saddle frame 18 illustrated comprises in particular two stays extending essentially in the longitudinal direction of the saddle. In a central region 20 of the two stays of the saddle frame 18, the same can be connected to the saddle post via a fastening element. Of course, it is also possible to fasten the saddle to the saddle post in another way.

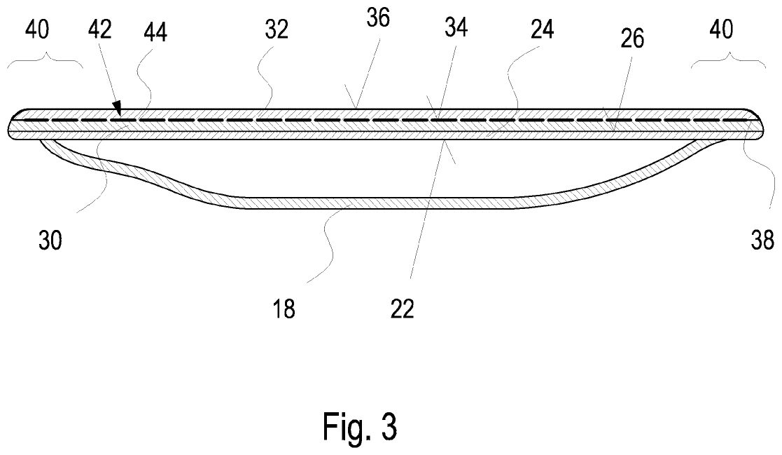

The saddle of the disclosure comprises a saddle shell 24 (FIG. 3) made of a relatively rigid material, wherein the saddle frame 18 is connected to the lower side 12 thereof. A saddle cushion 28 is arranged on an upper side 26 of the saddle shell 24. In the embodiment illustrated the saddle cushion 28 comprises a lower cushion element 30 as well as an upper cushion element 32. In the embodiment illustrated the lower cushion element 30 covers the entire upper side 26 of the saddle shell 24. Further, the upper cushion element 32 covers all of the surface of an upper side 24 of the lower cushion element 30.

Further, an upper side of the upper cushion element 32 is spanned with a cover layer 36. The edge region 38 of the cover layer 36 is arranged in the region of a saddle edge 40 between the two cushion elements 30, 32.

A connection layer 42, which in the embodiment illustrated is designed as a perforated film, is provided between the lower cushion element 30 and the upper cushion element 32. The connection layer 42 extends between the entire upper side 34 of the lower cushion element 30. The connection layer 42 possibly has irregularly arranged recesses or holes 44.

The connection layer 42 is preferably connected to the lower cushion element 30 already during the manufacture of that cushion element. For example, the connection layer is placed in a corresponding mold that serves to manufacture the lower cushion element. The connection of the connection layer 42 to the upper cushion layer 32 can be effected using heat, chemical reactions or the like.

1. A bicycle saddle comprising
a saddle shell,
a saddle frame arranged on a lower side of the saddle shell, and
a saddle cushion arranged on the upper side of the saddle shell,
wherein the saddle cushion comprises at least two cushion elements overlapping each other at least partially,
wherein
a connection layer is arranged between at least two cushion elements.

2. The bicycle saddle of claim 1, wherein the connection layer comprises a film or a non-woven.

3. The bicycle saddle of claim 1, wherein the connection layer comprises recesses and is perforated.

4. The bicycle saddle of claim 1, wherein a lower cushion element of the at least two cushion elements rests on the upper side of the saddle shell.

5. The bicycle saddle of claim 1, wherein the connection layer is arranged exclusively in a sitting region.

6. The bicycle saddle of claim 1, wherein the connection layer is pre-tensioned transversely to the longitudinal direction of the saddle.

7. The bicycle saddle of one of claim 1, wherein the connection layer is multi-layered.

8. The bicycle saddle of claim 1, wherein the connection layer comprises fiber material, wherein the fiber orientation extends in the longitudinal direction of the saddle or transversely to the longitudinal direction of the saddle.

9. The bicycle saddle of claim 1, wherein an upper side of the at least one of two cushion elements between which the connection layer are arranged, comprises a recess in which the connection layer is arranged.

10. The bicycle saddle of claim 1, wherein the connection layer comprises synthetic or organic fabric.

11. The bicycle saddle of claim 10, wherein an upper cushion element of the at least two cushion elements covers all of a lower cushion element.

12. The bicycle saddle of claim 1, wherein at least one of the at least two cushion elements comprises a particulate foam.

13. The bicycle saddle of claim 1, wherein an upper cushion element of the at least two cushion elements rests on an upper side of a lower cushion element.

14. The bicycle saddle of claim 1, wherein an upper cushion element of the at least two cushion elements comprises foamed material.

15. The bicycle saddle of claim 1, wherein the saddle cushion is spanned by a cover layer.
